(19) United States
(12) Patent Application Publication
(10) Pub. No.: US 2006/0232015 A1
(43) Pub. Date: Oct. 19, 2006

(54) Slide ring seal assembly

(76) Inventors: Günther Lederer, Geretsried (DE); Josef Nosowicz, Geretsried (DE); Jochen Reitberger, Wolfratshausen (DE); Andreas Schrüfer, Wolfratshausen (DE)

Correspondence Address: EDWARDS & ANGELL, LLP, P.O. BOX 55874, BOSTON, MA, 02205, US

(21) Appl. No.: 10/537,060

(22) PCT Filed: Oct. 16, 2003
(86) PCT No.: PCT/EP03/11500

§ 371 Date: Jun. 5, 2006

(30) Foreign Application Priority Data
Dec. 6, 2002 (DE) 202 18 878.7

(51) Int. Cl. F16J 15/34

(52) U.S. Cl. 277/362

(57) ABSTRACT

A slide ring seal assembly comprises at least one pair of interacting slide rings (4, 5) of which one is provided for mounting on a stationary part and the other is provided for rotating together with a rotating part and of which one is mounted in a manner that enables it to axially move and is axially pretensioned with a designated axial pretensioning force against the other slide ring by means of a spring bellows assembly (11). This spring bellows assembly comprises a first spring bellows (13) that, at one end, are supported on the respective slide ring and, at the other end, are supported on an annular divider element (12) mounted in a manner that enables it to axially move relative to the respective part, and comprises a second spring bellows (14) that, at one end, are supported on said divider element and, at the other end, are supported on the respective part. The divider element (12) can move counter to an axial frictional force relative to the respective part, said axial frictional force being at least equal to a designated maximum operating vibratory force. Vibrations are prevented from being transferred to the second spring bellows so that only the first spring bellows are subjected to vibratory stresses.

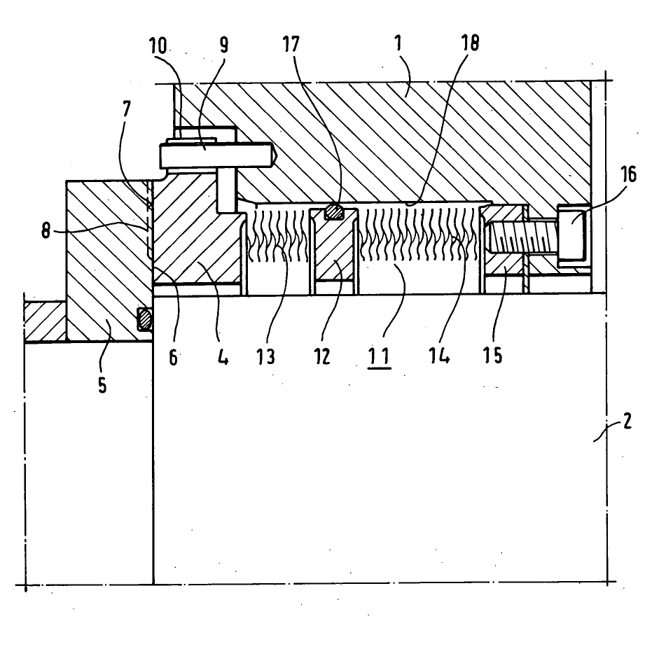

The invention relates to a slide ring seal assembly in accordance with the preamble of claim 1.

The invention relates in particular to a slide ring seal assembly comprising a biasing and secondary sealing means in the form of a spring bellows of metallic material. The spring bellows can be subjected to considerable vibratory and thermal stresses which can lead to damage to the spring bellows itself (cracking) and may have harmful effects on the mutual alignment of the seal rings and on the conditions in the region between the cooperating sealing faces of the seal rings. In steam driven plants, e.g. steam turbines, it is desirable to use spring bellows having a comparatively large axial length since they provide adequate flexibility for compensating for thermal expansions and, moreover, they allow mounting inaccuracies to be easily dealt with. For the purposes of damping the vibrations in the spring bellows arising in such applications due to the rotation of the shafts, proposals have already been made for dampers consisting of e.g. structured metal strips which are arranged between the bellows and a surrounding surface of a component of the slide ring seal assembly. This vibration-damping measure entails unwanted damage to the surface of the bellows. Furthermore, in the case of a spring bellows of considerable axial length, it is also known to provide an axially freely moveable guide element at an intermediary location in order to counteract the danger of buckling of the bellows.

The object of the invention is to provide a slide ring seal assembly of the type mentioned hereinabove comprising a biasing and secondary sealing means in the form of a spring bellows wherein the harmful effects of vibrations on the operational behaviour of a seal ring pair and on the life time of the spring bellows assembly itself are completely eliminated or at least eliminated insofar as possible. In particular, an improved slide ring seal assembly comprising a spring bellows assembly of enlarged axial dimension for application in steam-driven plants is to be provided by the invention.

In accordance with the invention, this object is obtained by a slide ring seal assembly including at least a single pair of cooperating seal rings, of which one is intended to be mounted on a stationary component and the other is for rotation in common with a rotary component and of which one is axially moveable and axially biased against the other seal ring under a predetermined axial biasing force by means of a spring bellows assembly. The spring bellows assembly comprises a first spring bellows supported at one end on the seal ring concerned and at the other end on an annular divider element arranged to be axially moveable relative to the component concerned, and a second spring bellows supported at one end on the divider element and at the other end on the component concerned. Thereby an axial operating vibratory force is superimposed on the predetermined axial biasing force in operation. In accordance with the invention, the divider element is moveable relative to the component concerned against an axial frictional force which is at least essentially equal to a predetermined maximum operating vibratory force. This can be defined in accordance with a preferred embodiment of the invention by a predetermined axial deflection of the first spring bellows.

The measures in accordance with the invention prevent vibrations from being transmitted to the second spring bellows so that only the first spring bellows is exposed to vibratory loads. The harmful effects of the vibrations can be dealt with more easily in this first section of the spring bellows assembly than in a bellows of great length, in that, in particular, the resonant frequency behaviour of the vibratory system consisting of the first spring bellows and the seal ring cooperating therewith can be tuned in such a way that the occurrence of harmful resonances is prevented. At the same time, the advantages of long spring bellows in regard to the compensation of thermal expansions and compensation for mounting inaccuracies are retained in their entirety. Moreover, in addition to its vibration isolating property, the divider element is effective as a stabilizing means in that it can effectively prevent buckling of the spring bellows.

The invention is described in more detail hereinafter with the aid of an embodiment and the drawing. The drawing shows a slide ring seal assembly in accordance with an embodiment of the invention in the form of a partly schematic longitudinal sectional view.

Although, the invention preferably offers advantages for the sealing of gaseous media including vapours in an environment wherein high thermal stresses and high rotational speeds are simultaneously present, the invention is not restricted thereto. The invention can also be advantageously used especially in connection with non-gaseous media.

The slide ring seal assembly according to the invention comprises a stationary component 1, e.g. a mounting gland or the like with the aid of which the slide ring seal assembly can be mounted in a boring of a not shown housing of a machine, e.g. a turbine. However, the stationary component 1 could also be the housing of the machine. A rotary component 2, e.g. a turbine shaft, is passed through a boring in the stationary component 1. Furthermore, the slide ring seal assembly comprises a pair of cooperating seal rings 4, 5, of which one, namely the seal ring 4, is mounted on the stationary component 1 in non-rotatable but axially moveable manner. In particular for this purpose, pins 9 may project axially from the stationary component 1 and engage in mutually aligned axial recesses 10 in the seal ring 4 so that the seal ring 4 is prevented from rotating relative to the stationary component 1 on the one hand, but can perform an axial movement on the other hand. The other seal ring 5 is intended for rotation in common with the rotary component 2 and is connected thereto in torque transmitting manner.

The cooperating seal rings 4, 5 have sealing faces 6, 7 opposed to each other, between which a sealing gap is formed during operation so as to seal an outer peripheral space of the seal rings 4, 5 with respect to an inner peripheral space thereof. As is indicated by 8, pumping structures can be formed in one of the sealing faces 6, 7, preferably that of the rotary seal ring 5, said structures opening into the outer peripheral space and causing the medium located therein to be pumped into the region between the sealing faces 6, 7 in order to assist the formation of the sealing gap. It is self evident that if the medium being pumped is present on the inner periphery of the seal ring pair, the outlets of the pumping structures should lie on the inner periphery of the seal ring concerned. In regard to suitable pumping structures, reference can be made to BURGMANN, Gasgeschmierte Gleitringdichtungen (Gas-lubricated axial face seals), self published 1997, pages 16 et seq.

A spring bellows assembly bearing the general reference number 11 is provided in order to urge the stationary seal ring 4 against the rotary seal ring 5 under a suitable biasing force so that the sealing faces 6, 7 will be held in sealing engagement with each other in the event that a sealing gap fails to be formed or the formation thereof is inadequate. Furthermore, the spring bellows assembly 11 forms a secondary seal for sealing the seal ring 4 with respect to the stationary component 1. Although other types of spring bellows could be used for the spring bellows assembly 11, it is preferred that it be formed of a metal bellows which is described with further details in BURGMANN, Lexikon der Gleitringdichtung, self published 1988, page 153, so that reference can be made thereto.

The spring bellows assembly 11 has an enlarged axial length so that it is suitable for accommodating correspondingly large thermal expansions such as can occur in operation of the slide ring seal assembly. In accordance with the invention, the spring bellows assembly 11 is axially subdivided by a divider ring 12 into a first spring bellows 13 and a second spring bellows 14. The first spring bellows 13 is supported at one axial end thereof on the seal ring 4 and on the divider ring 12 at the other axial end thereof in sealing manner, whereas the second spring bellows 14 is supported in sealing manner at one axial end thereof on the divider ring 12 and the other axial end thereof is supported on a mounting ring 15 which can be mounted on the stationary component 1 in suitable manner, e.g. by means of a bolt connection as is indicated by 16. The second spring bellows 14 could also be directly supported on the stationary component 1. The sealed connection of the spring bellows 13, 14 to the components on which they are supported at the ends thereof, could also be effected by welding or other suitable connecting techniques.

The divider ring 12 is of stable, disc-like construction and, in the outer periphery thereof, it contains a peripherally extending groove or retaining means in which an annular friction element 17 is arranged. The annular friction element 17 can be a spring washer or a ring of a resilient material, e.g. an O-ring. Preferred forms of spring washers are those wherein the spring coils are arranged such that a spring action is produced not only in the longitudinal direction but also in the radial direction. Such spring washers can be obtained under the designation BAL SEAL-FEDERN from Plasticell Vertriebs GmbH, Radolfzell, Germany.

For the functioning of the friction element 17, it is important that it is held in contacting engagement with a neighbouring peripheral surface 18 of the stationary component 1 by means of a predetermined radial force so that a frictional force will develop if the divider ring 12 is axially displaced between the friction element 17 and the peripheral surface 18, said force resisting an axial movement of the divider ring 12. Without the friction element 17, the divider ring 12 could move freely back and forth along the shaft 2 in the course of a possible axial deflection of the spring bellows 13, 14. An axial vibration transmitted from the seal ring 4 to the first spring bellows 13 would therefore be transmitted unhindered through the divider ring 12 to the second spring bellows 14. Because of the length required for the spring bellows assembly 11, a system of uncontrolled dynamic behaviour would ensue, and this could lead to “opening” of the seal rings 4, 5 or damage to the spring bellows assembly 11. On the other hand, it is necessary for the spring bellows assembly 11 to be of a sufficient length in order to enable it to accommodate the thermal expansions arising in operation.

The radial force with which the friction element 17 is biased against the peripheral surface 18 is selected in such a way that an axial frictional force is developed which, under normal operating conditions, is so large that the divider ring 12 will remain in an axial position into which the divider ring 12 would be displaced due to the thermal expansion of the spring bellows assembly 11 or due to other macro-movements, by virtue of the axial biasing forces exerted on the part of the first and second spring bellows 13, 14. In particular, the frictional force causes the divider ring 12 to remain immovable despite the micro-vibratory movements in the first spring bellows 13 which occur in operation and to which said bellows can be excited by the rotation of the rotary component 2. These micro-vibratory movements are thereby prevented from being passed on to the second spring bellows 14. These micro-vibratory movements cause axial operating vibratory forces in the first spring bellows 13 in accordance with the spring constants thereof, which are superimposed on the predetermind static biasing force applied by the spring bellows assembly 11.

Experiments that have been carried out in the context of the invention have shown that the frictional force with which the divider ring 12 is held in its axial position should be selected such that it corresponds to an operating vibratory force caused by the micro-vibratory movements with a maximum axial deflection of the first spring bellows 13 of no more than ±0.5 mm, preferably ±0.4 mm, and most preferably ±0.3 mm. In the case of deflections which remain below these limits, no such axial force is exerted on the divider ring 12 on the part of the first spring bellows 13 by virtue of which the frictional force between the friction element 17 and the peripheral surface 18 can be overcome. Consequently, the divider ring 12 remains at rest under the effect of vibratory forces and can thus reliably prevent the transmission of vibrations from the first spring bellows 13 to the second spring bellows 14.

The first spring bellows 13 and the second spring bellows 14 can have equal or different axial dimensions. In some fields of application, it is preferred that the axial dimension of the first spring bellows 13 should be smaller than that of the second spring bellows 14. The first spring bellows 13 and the associated seal ring 4 represent a vibratory system having a certain natural frequency. The mass of the seal ring 4 and that of a (not shown) thrust ring possibly added thereto and the spring constant of the first spring bellows 13 should be adapted to the estimated highest operating speed of the rotary component so in that the exciting frequency resulting therefrom always remains below the natural frequency of the vibratory system.

In the embodiment of the invention described above, the spring bellows assembly is associated with the non-rotating seal ring. If so desired however, it could also be associated with the rotary seal ring. In this case, provision must be made for the friction element of the divider ring to be able to cooperate with a rotating peripheral surface, e.g. the surface of the rotary component. In place of a slide ring seal assembly having only a single seal ring pair, a tandem or twin pair could also be provided. As an alternative, a divider ring having a separate friction element could be replaced by a divider ring formed of a suitable tribologically effective material.

1. A slide ring seal assembly including at least a single pair of cooperating seal rings, one of said seal rings is provided for mounting on a stationary component and the other for common rotation with a rotary component, and one of said seal rings is axially moveable and axially biased under a predetermined axial biasing force against the other seal ring by means of a spring bellows assembly, said spring bellows assembly comprising: a first spring bellows supported at one end on the seal ring associated and at the other end on an annular divider element arranged axially moveably relative to the component concerned, and a second spring bellows supported at one end on the divider element and at the other end on the said component concerned, whereby in operation an axial operating vibratory force is superimposed on the predetermined axial biasing force, said divider element can move axially relative to said component concerned against an axial frictional force which is at least essentially equal to a predetermined maximum operating vibratory force.

2. The slide ring seal assembly according to claim 1, wherein said maximum operating vibratory force corresponds to an axial deflection of the first spring bellows (13) of ±0.5 mm, preferably ±0.4 mm, most preferably ±0.3 mm.

3. The slide ring seal assembly according to claim 1, wherein the second spring bellows has a greater axial length than the first spring bellows.

4. The slide ring seal assembly according to claim 1, wherein the divider element is biased against said component concerned by a radial force which is at least essentially equal to the relationship of the maximum operating vibratory force and a static coefficient of friction between the divider element and the component.

5. The slide ring seal assembly according to claim 1, wherein a friction element having radial flexibility is arranged peripherally of the divider element.

6. The slide ring seal assembly according to claim 5, wherein the friction element is a spring washer.

7. The slide ring seal assembly according to claim 5, wherein the friction element is a ring of a resilient material.

8. The slide ring seal assembly according to claim 1, wherein the spring bellows assembly is associated with the stationary seal ring.
